(19) United States
(12) Patent Application Publication
(10) Pub. No.: US 2008/0032799 A1
(43) Pub. Date: Feb. 7, 2008

(54) NETWORK GAME TOURNAMENT AND BROADCASTING

(75) Inventors: Russell Hamilton, Las Vegas, NV (US); Brett D. Calapp, Las Vegas, NV (US); Sanford I. Millar, Los Angeles, CA (US); Frederic David JR., Las Vegas, NV (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: ULTIMATE BLACKJACK TOUR, LLC, Los Angeles, CA (US)

(21) Appl. No.: 11/737,064

(22) Filed: Apr. 18, 2007

Related U.S. Application Data
(63) Continuation-in-part of application No. 11/275,252, filed on Dec. 20, 2005.
(60) Provisional application No. 60/729,190, filed on Oct. 21, 2005.

(51) Int. Cl. A63F 13/00

(52) U.S. Cl. 463/42

(57) ABSTRACT

A computer networked tournament in a subscription and non-subscription system is presented. There is a multi-round blackjack tournament with elimination hands and periodic hands where players with the lowest chip or point total are eliminated from the game. In a home/portable edition implementation players conduct a card game tournament in venues outside of the traditional casino environment. There is broadcast on television of a tournament of winners from qualifying networked game tournaments, the television the broadcast being a final or pre-final game of a networked game tournament.

### RELATED APPLICATION

This application is a continuation-in-part of U.S. Utility patent application Ser. No. 11/275,252, filed Dec. 20, 2005, which claims the full benefit and priority of U.S. Provisional Application Ser. No. 60/729,190, filed Oct. 21, 2005, the contents of which are incorporated by reference herein in their entirety.

### BACKGROUND

1. Field

The present disclosure relates to method and apparatus for a network game tournament, and a related television broadcast of the game, for instance a card game tournament.

More specifically, the present disclosure provides for a method for a card game tournament for card games such as blackjack, with elimination rounds and secret bets to further increase the entertainment value for players and spectators alike. Also provided for is an apparatus for conducting the disclosed card game tournament in venues such as a person's home.

Further, there is a provision and system for broadcasting a tournament relating to the game which is preferably a card game.

2. General Background

Over the last few years, the popularity of poker tournaments has grown substantially, owing in part to the rapidly growing number of poker players and interested observers. Television cable channels now routinely broadcast poker tournaments, and games such as those featuring celebrities receive particularly good ratings. Observing a game of poker can at times lack entertainment value because of the slow pace, and some viewers may fail to appreciate subtle but important nuances of poker strategy. However, as the popularity of the game of poker grows, viewers are often attracted not just for the pure entertainment value, but for the chance to learn from “the masters” and gain insight into the less apparent aspects of poker strategy and tactics.

Also gaining popularity is the card game “blackjack”, which was already well known and has been played for many years. In its present conventional or electronic form, this game is played in almost every major casino in the United States. Blackjack shares a fast-paced play environment with other table games such as roulette and craps, yet offers the opportunity for players to utilize some level of skill to increase game winnings. Blackjack further owes its popularity to an uncomplicated rule set, as well as the publicity that arises from news stories of high skill players that have received substantial winnings. Further, unlike poker, blackjack players play against the house rather than other players.

The simplicity of the blackjack game along with its rapid play provides the potential for high observational interest, yet blackjack tournaments have failed to be as commercially successful as poker tournaments, especially in the television broadcast realm. The lagging effect of blackjack tournament popularity may be attributable to the absence of factors that can increase the playing tension between the players and provide for more opportunities for strategic betting decisions.

What is needed, therefore, is a method for conducting a blackjack tournament that increases viewer interest. What is additionally needed is a blackjack tournament method that provides new play opportunities to increase competition between players and that supports the use of an overall game strategy to increase likelihood of player success. What is further needed is a method of conducting a tournament that spurs user excitement by allowing for elimination of players at particular times during the tournament. What is also needed is a blackjack tournament method that allows the live viewer or television audience to see cards or bets not within view of other players. What is also needed is a method and apparatus to allow players to conduct their own blackjack tournaments, as disclosed herein, yet outside of a casino environment such as in the comfort of their own homes.

Additionally, there is a need to enhance tournament games, such as card games, by providing broadcasting perspectives and features to the game.

### SUMMARY

A method is provided for conducting a card game tournament in one or more rounds, with the possibility of elimination at several points within a round. In each round, comprised of a predetermined number of hands, at certain intervals, “elimination hands” may be declared, wherein after the hand is played, the player with the lowest score, point count, or chip total will be eliminated, therefore expediting play of the tournament and heightening viewer suspense as the player to be eliminated is determined. Further, such elimination hands cause players to adjust their play style, since for elimination hands, the players are competing more directly against one another to avoid the penalty of elimination. At the end of a round, the player with the highest player total (in tokens, chips, point value, or dollars, for instance) will advance to the next round. After the final round is completed (e.g., the championship round), the player with the highest score, point count, or chip total is winner of the tournament. If two players are tied for the highest point total, a playoff will be held to determine which player advances.

It is another object of the disclosure to provide for a betting technique to further increase viewer interest and excitement of the tournament. Once or more per tournament, another implementation of the present disclosure provides for a “secret bet,” where players may place a bet in confidence, with the amount not known to other players until the end of the hand when bets are resolved. However, the present disclosure provides for a means to reveal the bet to a viewing audience, a broadcast audience, or both, at the time the bet is placed (or thereafter). One such means for revealing a secret bet may be accomplished by displaying a video feed on a visual display that is viewable only by members of an intended live or remote audience. In this way, viewers have knowledge of potential game outcomes that players may not, and therefore viewers become more drawn into observing game play. Further, the secret bet aspect of the present disclosure allows for players to exercise gaming strategy more akin to the game of poker, where “bluffing” plays a key role in adding an element of the unknown. In one implementation of the present disclosure since player cards are visible to other players the secret bet has the effect of allowing a player to exercise confidential strategy and force other players to adjust play technique accordingly.

It is another object of the disclosure to provide for an apparatus and method to conduct a blackjack tournament in a venue outside of a casino or studio environment. With viewer interest likely increasing in response to the broadcast of tournaments conducted in accordance with the present disclosure, viewers may become motivated to play in such tournament themselves, host their own tournaments, or conduct tournaments at a public forum such as for fundraising. In these situations, the method and apparatus of the present disclosure provide for game components and rules to support the implementation of a blackjack tournament at a venue outside of a typical casino or studio environment.

It is another object to provide as a prize for winning a qualifying tournament game, the opportunity to be a participant in a television show for broadcasting publicly. More specifically, the television show is a tournament game with different players being winners from qualifying tournament games.

A computer networked, multi-user game system is provided with a subscription based membership and alternative methods of entry.

A game or a tournament is hosted by a game server computer coupled to one or more client computers operated by participating players. The game typically has elements of both skill and chance. There is active participation and decision making by a player, or alternatively, the game may be mostly chance.

A subscription-based membership can be established for each player by charging each player a fee for a pre-determined membership time period. Each player selects a game or tournament to be played against other players over the computer network and registers to play that game or tournament. Chips or tokens can be allocated to each member player participating in the online game or tournament for betting in the game or tournament. Alternatively in some situations, subscription permits entry to the game.

An alternative method of entry allows non-subscription players to participate in the online game or tournament without payment of the subscription fee.

The game server hosts at least one game or tournament during the membership time period, and the online game or tournament includes at least one game round. After completion of the game or tournament, one or more prizes are disbursed to the winning player and any eligible runner-up players. These prizes can include participation in a subsequent television show game.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 depicts a flow chart portraying one method of the present disclosure, wherein a card game tournament is conducted.

FIG. 2 illustrates a flow chart for one embodiment of playing a hand of cards in accordance with the present disclosure.

FIG. 3 is a high-level flow diagram of the network system.

FIG. 4 is a detailed flow diagram showing the subscription system working with a television show with a new player.

FIG. 5 is a flow diagram showing the subscription system working with registered players who are either eligible or non-eligible participants.

The same numbers are used throughout the disclosure and figures to reference like components and features.

### DETAILED DESCRIPTION

An implementation of the present disclosure provides for a card game tournament conducted in one or more rounds, each round comprising one or more hands of cards. In one implementation, a round of the tournament comprises 30 hands played, or in some situations, may comprise 10 to 60 hands played. A round may end before the predetermined number of hands is played, and may continue longer to break ties. A sufficient number of rounds is played to eliminate players and determine an ultimate champion. One implementation further provides for a card game tournament utilizing the game of blackjack.

There is a computer-implemented method of allowing a plurality of players to play a game over a computer network. Memberships are established for each of the plurality of players by charging each of the players a fee. Several game tournaments for players for a game that has elements of chance during the membership period are established. The tournaments include at least one game round, and each game round potentially eliminates one or more participant players until a winning player is determined. Each of the participant players is required to make playing choices throughout the game. A non-member player, namely a non-subscriber, participates in at least one of the tournaments without payment of the fee by submitting information relating to the non-subscription player prior to the hosting of the tournament. There is no limit to the number of tournaments that can be played by the non-member player, namely the non-subscriber without payment.

A prize for the tournaments is participation in a game tournament for broadcast as a television program. The game tournament on a television includes as a player at least one other winner from another game tournament. There is a further prize to the winning player of the tournament broadcast on television.

The game tournament is managed by a game administrator operating a game server computer coupled to one or more client computers operated by the participating players. Also the computer network comprises the Internet, and the game comprises a card game, such as blackjack.

In some cases there are players playing a game on a non-networked tour comprising different games in different tournaments.

In one form the tournament is a card game tournament played in accordance with predetermined game rules by a plurality of players playing a predetermined number of hands in a predetermined number of rounds of the card game tournament.

The rules include designating at least one said hand in each said round as an elimination hand in which for each said player, a chip total is derived from each said player's cards, and each said player's chip wager. The player having the lowest said derived chip total is eliminated.

Other aspects include:

(a) determining a player wager and play order;

(b) placing bets by the plurality of players in order of said wager and play order;

(c) dealing a plurality of cards to the one or more players in order of said wager and play order;

(d) making play decisions, by the players;

(e) resolving, according to the predetermined game rules, whether said play decisions result in said players forfeiting their bets or receiving payouts; and

(f) accumulating new player chip totals as a result of step (e).

There can be a time limit for making play decisions, and if a player fails to make one of said play decisions within said time limit, said player is compelled to stand with dealt cards. The time limit is established at one value for a non-elimination hand, and a second value for an elimination hand. Players can be eliminated who are unable to place at least a mandatory minimum bet. At least one of said bets can be a secret bet. One or more hands as elimination hands can be designating hand numbers 8, 16, and 25.

In another form the tournament is a card game tournament played in accordance with predetermined game rules by a plurality of players wherein there is wagering in a hand of cards. Before cards are dealt, a player renders indicia of a hidden bet, the indicia indicating a first monetary value of the hidden bet; and after cards are dealt, the player modifies the indicia to a second monetary value of the hidden bet.

In yet another form the tournament is a card game tournament played in accordance with predetermined game rules by a plurality of players, wherein there is a card game tournament with a predetermined number of rounds and hands to be played in each of the predetermined number of rounds. One or more of said hands to be played is an elimination hand. Before cards are dealt, one or more players render an indicia of a hidden bet, the indicia indicating a first monetary value of the hidden bet. After cards are dealt one or more said players can modify the indicia to a second monetary value of the hidden bet.

In yet another form the card game tournament includes wagering in a hand of cards. Before cards are dealt there are indicia of a hidden bet of a player; a monetary value of the hidden bet of the player is shown before a camera; and the monetary value of the hidden bet is revealed to at least one person not participating in the hand of cards.

The camera is situated at a location not visible to a second player participating in said hand of cards, and said one person not participating in said hand of cards views an image produced by said camera. The camera produces a video feed, and the video feed is recorded for broadcast. Also the video feed is transmitted by radio frequency broadcast. The video feed is provided to a cable television network. The video feed is distributed to subscribers of a cable television service, and the video feed from said camera is displayed to an audience.

The tournament includes a plurality of players playing a hand of blackjack. Each player is dealt at least two cards, and each said player optionally places a secret bet token on the blackjack table; and a secret bet card indicating a secret wager under the secret bet token. After each player is dealt at least two cards, each said player optionally placing an additional wager; and after a result is determined for each player's hand, each secret wager is revealed; and for each said player, the secret and additional wagers are summed.

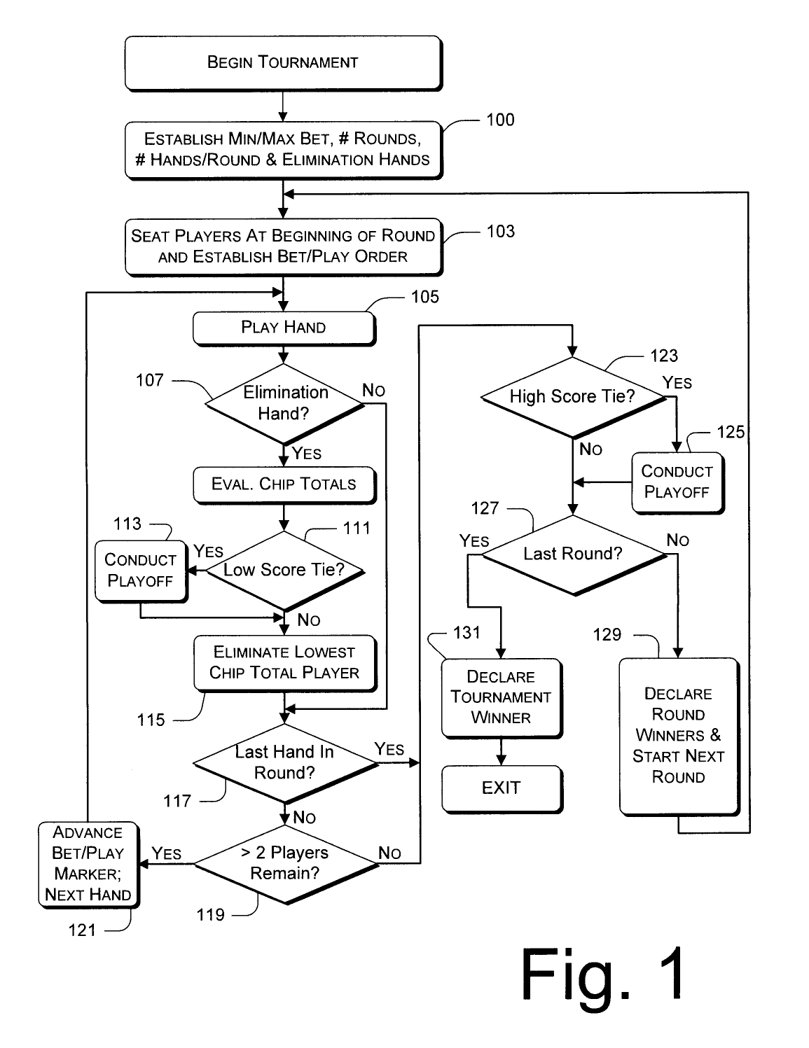

Turning to FIG. 1, a flowchart of an implementation of the present disclosure is presented. At the beginning of the tournament, certain game play parameters are established (100), such as the minimum and maximum allowable bet/wager, the number of rounds in the tournament, the time limits to place bets and to act upon dealt cards, and the number and cardinality of elimination hands (discussed more fully below). In one implementation hand numbers 8, 16, and 25 are designated as elimination hands, where players may be eliminated under certain conditions. Further, while in one implementation elimination hands are announced before the tournament begins, in an alternate implementation to further increase the spontaneity and enjoyment of the game, elimination hands may be declared at the beginning of a round, at the beginning of an elimination hand, or after an elimination hand of cards had been played without a player's knowledge that such hand was an elimination hand.

At the beginning of each round of the tournament (103), players are seated in the game and an initial play/seating order is determined, such as through a random draw. Those of skill in the art understand that since the order of play typically proceeds sequentially from one player to the next in the seating order, the terms “play order” and “seating order” are interchangeable, and are to be considered interchangeable herein. It is understood that in some implementations, such as in a computer-implemented tournament, not all players must necessarily physically reside at the same location. It is further understood that the number of players in each game or table may vary due to the number of entrants in the tournament. In one implementation a physical or virtual marker is placed proximal to the player that is first in the bet/play order, and such marker is rotated to a next player after completion of play of each hand of cards. In an alternate implementation, such marker also provides indicia of which hand number is being played within a round and/or whether such hand comprises an elimination hand. During this phase (103), players receive an initial allocation of tournament chips or a monetary indicia of value ($25,000 worth, in one implementation, or in a home edition implementation players each receive $100,000 in chips). If the round being played is a final, or championship round, players optionally receive a different allocation of chips or monetary value ($100,000, for instance). With the exception of the final round, players may vary their bets within predetermined limits, for instance from $500 to $25,000 in increments of $100. In the final championship round, or in a home version of the present disclosure, players may vary their bets in a second range, for instance from $1,000 to $100,000 in increments of $100. It is understood by those of skill in the art that bet limits may be adjusted responsive to the length of the tournament, the number of rounds to be conducted, the nature of players involved, or the venue of the tournament. In one implementation once bets are placed in the player's betting square, the bets may not be changed.

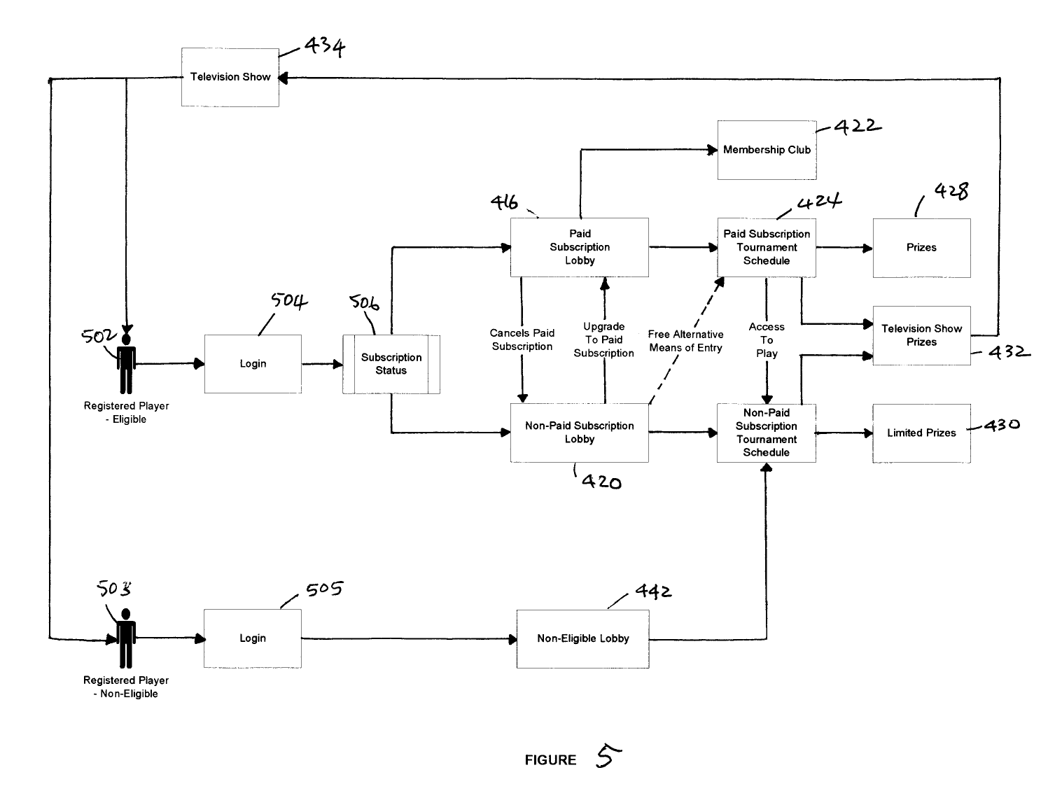

The hands of each round are played (105) with rules determined by the nature of the card game tournament being conducted. In one implementation, the rules of the card game are substantially similar to established casino blackjack rules. One implementation of playing a hand in accordance with an implementation of the present disclosure will be discussed more fully below in relation to FIG. 5, below. At the completion the playing of a hand of cards (105), each player's point, chip, or monetary value indicia totals will be adjusted based on their respective success or failure in that hand of cards.

If a hand played was designated as an elimination hand (107), players' point/chip/value totals are accrued and compared (109). If two or more players tie for lowest total (111), then a playoff is conducted (113) to determine a player with the lowest chip total. After the optional playoff (113), the player that has the lowest remaining total is eliminated (115).

In one implementation a playoff (113) may be conducted as follows. First, a the number of hands in the playoff is determined and may be set equal to the number of players tied at the beginning of the playoff. The first bettor in a playoff, in one implementation, is the player who is naturally positioned to bet next following the preceding hand. At the beginning of the playoff, in one implementation, the tied players start with the same value of chips or monetary indicia that they had at the conclusion of the hand (105), and will play substantially in accordance with the rules of a non-playoff hand. In an alternate implementation, prior to beginning the playoff, special playoff chips may be issued to the tied players to avoid intermixing chips with each player's pre-playoff chip total, and optionally, a predetermined amount of chips or value indicia could be issued to each tied player irrespective of their pre-playoff bankroll. At the end of the playoff, the player with the lowest total is determined, and will therefore be eliminated (115). The player(s) surviving the playoff (113) will begin the next hand with the same total value of chips that each had at the conclusion of the hand that preceded the playoff.

After an optional player elimination, the play of a round continues with determining whether a hand was the last hand in a round (117). If not, in one implementation more than two players must remain (119) for the round to continue, otherwise the round will be concluded. If more than two players remain, and if it is not the last hand in the round, the marker or indicia that identifies the initial player/bettor in a hand of cards is advanced to the next surviving player in sequence (121) and play of a new hand begins (105). Otherwise, at the end of a round, the surviving player's chip totals, scores, or monetary value indicia are compared (123), and if there is a tie between two or more players for highest value, a playoff is conducted (125) in a manner similar to the method described above in relation to the elimination playoff (113), except that it is sought to be determined which of the tied players obtains highest point value in the playoff.

To conclude the round, the player with the highest point total will be determined (127) and designated the round winner if the tournament has not concluded (129). In such a case, round winners may be selected to play against each other in new tournament rounds (105). If the round being played was the final, or championship round in the tournament, then the player with the highest total is declared the tournament winner (131) and the tournament concludes.

While an implementation of the present disclosure provides for a card game tournament utilizing the card game of blackjack, it will be appreciated by those of skill in the art that other card games such as Baccarat, Pai Gow, and Caribbean Stud could be utilized. One implementation of blackjack play rules as follows: the deck may be dealt from a six deck shoe with approximately one deck of cards cut out of play, and the decks are combined and thoroughly shuffled. The dealer deals both initial cards face-up to the players and one card up and one down to himself. The dealer hits all hands of 16 or less and also hits soft 17. Players are paid 3 to 2 for “naturals” or “blackjacks” (a two-card hand consisting of an ace plus face card or a 10). Players may split any two-card hand which contains cards of equal value up to three times for a total of 4 hands. Split aces may be dealt only one card on each ace, and these cards are dealt down; if the down cards in ace splits are face cards or “10” cards, such split hands are not “naturals” or “blackjacks” but are treated as having a value of 21. The player may double down on any two cards, for any amount from the table minimum up to and including the amount of their original wager, and including after splitting, with the exception of split aces which are governed by the one card per ace rules above. All double down cards are dealt face down. Late surrender is allowed for one half of the player's original wager.

Turning to FIG. 5, to begin play of a hand (200), a player that is designated as the initial player/bettor, will place a bet/wager (203) and each surviving player in turn places bets. In one implementation, if a player is unable to place at least a predetermined minimum bet as announced with the tournament rules (205), then that player is eliminated (207).

In any hand during a tournament round of their choice, each player has the option (207) of placing a “secret bet”. In one implementation, players may be limited to placing a limited number of secret bets per round or per tournament, and for example but not by way of limitation, players may be restricted to placing no more than one secret bet per tournament round. At the time it is their turn to place a bet, a player using the secret bet option renders an indicia of a secret bet (209), such as by placing a designated “secret bet” chip in a betting square when it is the player's turn. At that point, the player placing the bet takes steps to record (209) the value of the secret bet being placed, such as by stepping away from the table to write the amount of the bet on a secret bet card or typing the value into a touchpad, keypad, or keyboard. The amount recorded on the secret bet card is held at least partially in confidence, and in one implementation no other players may observe the value of the recorded secret bet until the placing player's wager is resolved at the end of the hand. Further, in one implementation before writing down the value of the secret bet or otherwise rendering an indicia of its value, the secret betting player enters a booth that has an interior that is at least partially enclosed or concealed from other players. The player then records the amount of the secret bet in the booth, and optionally, reveals the amount of the bet to a camera that is installed in a manner so as to see the player within the booth. In one implementation the camera produces a video feed that may be broadcast, recorded, or displayed to an audience but not to other players that are currently engaged in the game. Those of skill in the art appreciate that such video feeds may be incorporated into an entertainment program that is recorded for later broadcast, or is transmitted live to a broadcast audience, a television audience, subscribers of a cable service, patrons of a casino, or bettors at a pari-mutuel betting facility. Such video feed may also be purposely time delayed to give program directors or editors time to remove uttered profanity or any other content that could be offensive to a viewing audience. Also, such video feed may be combined with or incorporated into other video feeds showing players not making secret bets.

After the amount of the secret bet has been rendered, in one implementation the secret bet card will be placed on the table under the secret bet token in the player's bet box, and play proceeds as usual. The amount of the bet is not revealed until the hand is over, and the hand is typically graded after the dealer has finished their hand. Additional wagers of either insurance or doubling down on the player's hand that contain the secret bet will be written in their appropriate space(s) on the secret bet card with the same provision that allows the player to walk away from the table when writing such secret bet information. In one implementation the player must have enough chips in the player's chip total to take insurance. No even money betting will be allowed.

If the secret betting player wishes to take insurance, double down, or split during the secret-bet hand, the player may similarly render the amount of the bet in confidence, such as by stepping away from the table and indicating such additional bets in the appropriate spaces on a secret-bet card. Such rendering of additional bet amounts may be conducted in a confidential booth area as discussed above, and optionally, may be visible to a camera for display to an audience, viewers or other designated attendees. At the end of the hand, after the dealer has completed play, the amount of the secret bet and any subsequent bets will be revealed. In one implementation if it is discovered that the player does not have sufficient chips to cover the secret bet, the bet will be considered to be the total amount of chips the player has remaining and the player will win, lose, or push that amount.

Splitting poses additional considerations for the secret bet process. If a player that has placed a secret bet has two cards of equal value and would like to split, the player should have enough chips remaining to do so before splitting the hand. Therefore, in an implementation of the present disclosure, a split bet that occurs by the secret bet option that cannot be covered by the player's current chip or monetary total may be considered to be a foul and the player will forfeit the entire original wager and split amount, further resulting in being eliminated from the tournament.

If a player wishes to double down on a secret bet, the player may do so, in one implementation, by writing down the amount of the double down bet on a secret-bet card in the appropriate space, or in an alternate implementation by typing or otherwise rendering the value of the secret bet in an electronic medium. When the wager is graded, if the player had enough chips to place the double down bet, then both bets have full action and are considered valid bets. If the player had sufficient chips or monetary value to make the full secret double down wager, then the wager will only be graded for the amount of chips or value that the player had at their disposal to wager, that is, the amount of the player's remaining chips or monetary value.

In one implementation once it becomes a player's turn to place a bet, the player must do so within a time limit specified at the beginning of the tournament. Those of skill in the art appreciate that in a virtual or distributed tournament, bets/wagers may also be placed by rendering indicia of monetary value either into a keypad or though a computer interface. In one implementation of timing rules, players have 20 seconds to place a bet on each hand and 20 seconds for each strategy decision on a hand. These time limits may be extended to one minute on each elimination hand and two minutes on the final hand in each tournament round, including the final round. Likewise, since placing a secret bet often takes more time than placing a normal bet, a different time limit such as two minutes may be imposed upon players to place secret bets after announcing they are placing such bets.

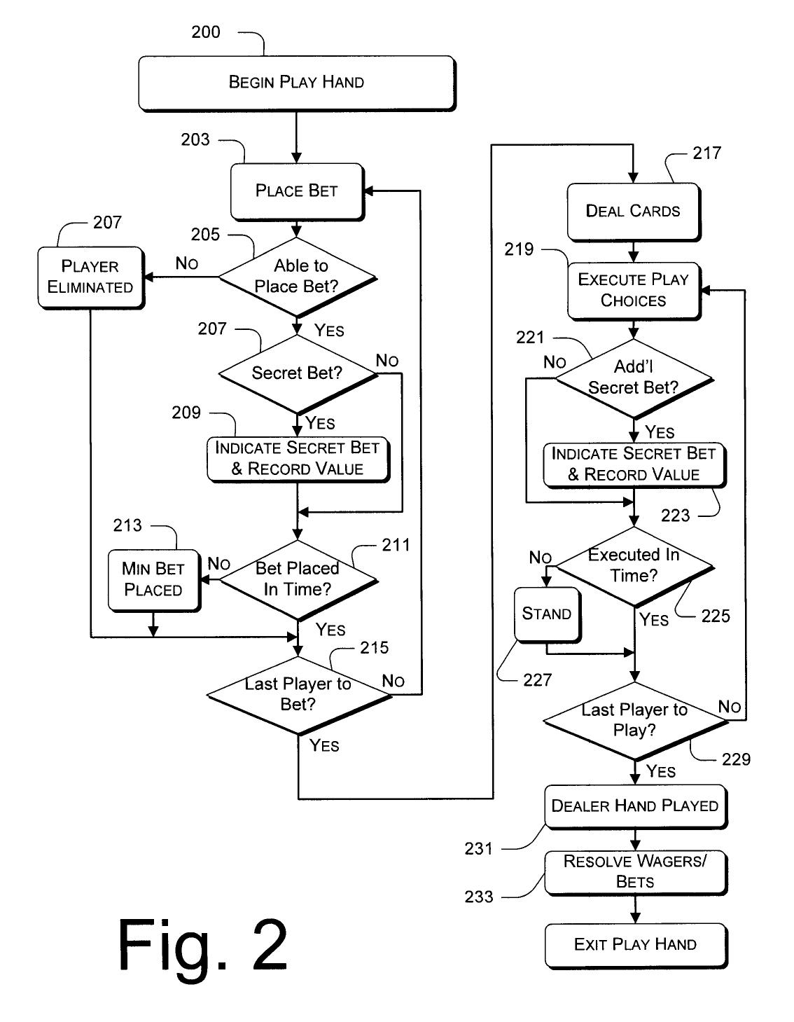

Referring to FIG. 2, if a player does not place a bet within the allotted time (211), that player's bet may automatically be set to the mandatory minimum bet (213).

Betting continues in a predetermined betting order until all bets have been placed (215), whereupon cards are dealt (217) starting with the initial bettor, and one at a time, players are presented with he obligation to specify play decisions (219). Since in the game of blackjack additional bets are required to split hands, double down, or take insurance, players that have placed secret bets may exercise the process described above to render a secret bet at least in partial confidence (221, 223). If a player does provide play decisions or otherwise act on the hand within the allotted time (225), the player will be considered to automatically stand (227). Play continues with each successive player (229) until the last player has conduced playing. The dealer then uncovers the dealer down card and plays the dealer's hand (231) in accordance with the tournament rules discussed above. Based on the dealer's hand, one at a time player bets are resolved (233), which may include revealing to all players the amount of any recorded secret bets. Since a new hand may be beginning, the initial player marker is advanced to the next player in turn, and the hand is considered completed.

Portable/Home Tournament Edition and Apparatus

Since it may be desired to provide for a version of the present disclosure that lends itself to play outside of a large-scale tournament venue, a method and apparatus for a home or portable edition of the tournament is presented. For example, but not by way of limitation, included in the game apparatus are a portable surface with indicia substantially similar to surface of a blackjack casino table, six decks of cards, a dealing shoe, a cut card, a dealer button, chips, hand-count chips, position-draw cards, secret-bet cards, and action cards. In one implementation, the portable surface with indicia comprises a foldable felt cloth with printed indicia. In another implementation, such indicia could be silk-screened onto the felt cloth. A timer device may also be included to ensure play progresses at the desired pace, and, for example, may measure betting and play execution times, such times being variable depending on the particular hand number being played.

Play begins substantially as above, with players receiving an initial amount of tournament chips. To keep track of the hand being played, the apparatus provides for hand-count chips designating the number of the hand that is being played. In one implementation, hand-count chips are numbered 1-30 with hands 8, 16, and 25 designated as Elimination Hands. On these designated Elimination Hands, the player with the lowest chip count at the end of the hand is eliminated from the game. If one or more players have fewer than the mandatory minimum bet in tournament chips at the end of the Elimination Hand, including when that amount is zero, those players are eliminated. Even if one or more players is eliminated before an Elimination Hand is played, at least one player may still be eliminated on the Elimination Hand.

In one home version implementation, hand number 30 is the final hand of the tournament. After hand 30, all chips are counted and the player with the highest total is declared the champion. The tournament can end sooner than hand 30 if only one player is remaining. If more than one player has less than the mandatory minimum bet left, the finishing order is determined by the count of all remaining chips.

Further, in a home version implementation, a rotating button determines where the betting and playing action begins on each hand. The button begins in seat one on hand one. Players' positions at the table may be determined by dealing out or drawing from the position-draw cards. Players will be positioned or seated in order, based on their card-draw result, with the ace or 1 designating that player to occupy the first seat and so on through the 7 card which will be designated as the last or seventh seat. The player in seat 1 makes the first bet, and betting continues in a direction, such as clockwise, until all players have bet in the hand. The cards are then dealt out in accordance with standard blackjack rules. Playing decisions are also made in order, beginning with the button player and continuing clockwise around the table. At the conclusion of hand #1, the #2 button will be placed in front of the next player in a clockwise rotation and that person shall bet first. In this manner, the button not only indicates the hand number but also the initial bettor/player in a hand. Betting and playing decisions on all hands begin with the button position until the tournament is completed.

In a home edition implementation, in case of a tie on any Elimination or final hand, the tied players will be given a predetermined amount of chips separate from the chips they have left and they will enter into a playoff that comprises two hands if two players are tied, three hands if three players are tied, and so on. The initial bettor/player button will start with the person to the left of where the button was at the end of the tied hand and will move to the next person in the playoff on the second and subsequent hands, if any, in the playoff. If the playoff results in another tie, the playoff is repeated in the manner just specified. After the playoff is completed, the person with the lowest chip count becomes the eliminated player. The remaining players, including the playoff survivor(s), will continue playing the tournament with the chips they had at the time the playoff began. Play continues after a player is eliminated with the button moving to the first surviving player to the left of the player who had the button on the hand that necessitated the playoff. If the playoff occurs on a final hand, the tournament will be completed and the winner of the playoff will be the champion.

In a home edition implementation, one secret bet per player per tournament round is permitted. Players are allowed to step away from the playing area to record their secret bet, and similarly to other embodiments discussed herein, multiple bets may be recorded on the secret bet cards, and other betting options such as surrender, insurance, double down, or split may be accommodated on the secret bet card in addition to an initial wager.

Use of a secret bet also entitles the player to use cards called “action cards” or the play of the secret-bet hand. Action cards allow players to record one or more desired play actions to be taken on the table, so that the desired play action is not known to the other players until the end of that hand. An action card may be used, for example, to keep the amount of a double-down or surrender bet concealed, or to conceal a decision to stand. Players are allowed to step away from the playing area to mark their action card. An action card may be used even if a secret bet was not made on the hand, and in one implementation, this will count as the player's one-time per tournament round use of the secret-bet or action option. In one implementation, secret bet or action cards are opened after the hand has been completed by all players and the dealer to determine how much the players bet, and/or what playing actions were desired to be taken. Bets will be paid or collected according to the outcome of the hand.

One implementation of a home edition of the present disclosure provides play rules as follows: normal blackjack rules will be in force, with the dealer having to hit all soft 17s (A-6, A-3-3, etc.) or any hard hand of 16 or less until a hard 17 or better is reached, at which point the dealer will stand. Players may double on any two cards, including on two-card hands after a split. Players may double for less than their original wager as long as it is not for less than the table minimum. Players may split pairs of equal-value cards, including mixed face cards, such as queen/king or ten/jack, up to three times to make a total of 4 hands. Aces, however, may be split only once with one card dealt to each ace. Late surrender is allowed on the player's first two cards. Surrendering a hand forfeits half of the amount bet. Early surrender (surrendering vs. a dealer ten or ace before the hand is checked for a natural) is not allowed. A player may take insurance if the dealer has an ace showing. A player must have enough chips to take insurance, and players may not take insurance by verbally saying “even money”. Insurance is allowed for any amount from half the mandatory minimum bet to half of the original wager. If the dealer does not have a natural or “blackjack”, the player's insurance wager is collected. If the dealer does have a natural, the insurance wager is paid at a rate of 2-1.

Further, in a home edition implementation, a countdown of all players' chips will take place after designated hand numbers, such as hand numbers 8, 16, and 25. In one embodiment, a countdown also occurs before the final hand un a round (for example, hand 30). If only two players remain in the game before the start of the Elimination Hand, the round will end at that point, and if no additional rounds or players remain, the tournament ends as well. In one implementation, to assist in fair game play, players must keep all chips stacked in the same denomination, in piles that do not exceed 15 chips.

The disclosure is further described in relation to a network distribution system. There are server and client computer systems which transmit and receive data over a computer network which can be hardwired and/or a wireless telecommunications network.

Accessing, downloading, and manipulating data, and other participation aspects are implemented by central processing units in the server and client computers executing sequences of instructions stored in memory. The memory may be a random access memory, read-only memory, a persistent store, such as a mass storage device, or any combination of these devices.

The instructions may be loaded into the memory of the server or client computers from a storage device or from one or more other computer systems over the network connection. A client computer can transmit a sequence of instructions to the server computer in response to a message transmitted to the client over a network by the server. As the server receives the instructions over the network connection, it stores the instructions in memory. The server can store the instructions for later execution, or it can execute the instructions as they arrive over the network connection.

A distributed electronic commerce application includes a client/server network system that links server computers to client computers, server computers to other server computers and client computers to other client computers. The client and server computers can be implemented as desktop personal computers, workstation computers, mobile computers, portable computing devices, personal digital assistant (PDA) devices, cellular telephones, game playing devices, digital audio or video playback devices, or any other similar type of computing device. The terms “computer network” and “online” include different network embodiments, for instance a LAN, WAN, or Internet.

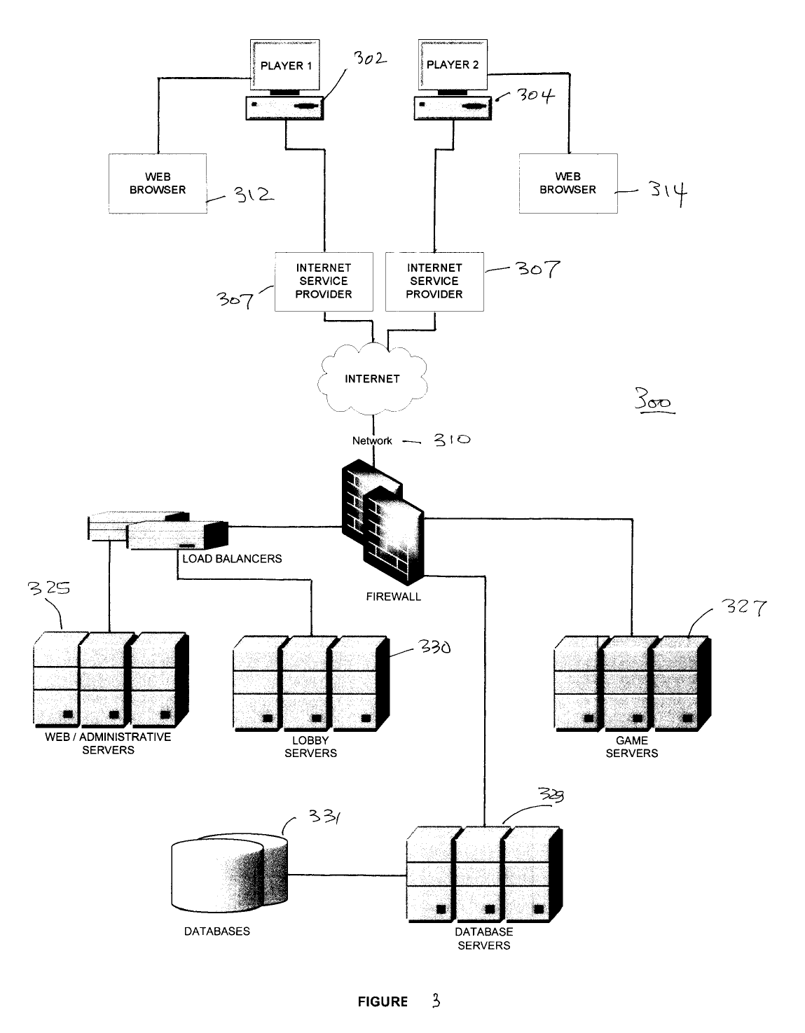

FIG. 3 illustrates an exemplary network that includes distributed client/server computers for the administration and execution platform of an on-line, multi-player blackjack game, or similar game involving elements of both skill and chance.

In system 300 one or more player/client computer users 302 and 304 access a game server computer 327 over a network 310 through a web server 325. Each player/client computer is typically operated by a single player. The client computer 302 is operated by “player 1” and the client computer 304 is operated by “player 2”. The game server 327 serves as the game platform by maintaining game play for tournaments and daily games that are accessed and played on the game server. The game software can include one or more client modules that are executed on each of the client computers, as well as server modules that are executed on the game server computer. Alternatively, all necessary game program modules may be executed on the game server computer 327 with minimal processing executed on the client computers 302 and 304.

Players are subscribers so as to participate in games hosted by the game server 327. A subscription lobby server 330 manages the tasks related to subscribing users and maintaining user accounts and subscriptions. Player profiles, subscription information, and all data relating to the games and tournaments are stored in a database 331 maintained by a database server 329. The database 331 can be stored in a separate memory device coupled to database server 329 or it can be stored in memory resident within server 329 or any other server.

For a network embodiment in which the client and server computers communicate over the World Wide Web portion of the Internet, each client computer 302 and 304 typically accesses the network through one or more Internet Service Providers (ISP) 307 and execute resident web browser programs 312 and 314 to display web content through web pages. Network 310 couples the client computers 302 and 304 to game server computer 327, which can execute a web server process locally or through a separate web server 325 that serves web content in the form of web pages to the client computers.

The game programs are executed on the game server computer 327 and each player accesses the game program through interface modules executed on their respective client computers 302 and 304. Depending upon the implementation of the game playing software, portions of the game programs may also be provided in client side software routines that are executed directly on the client computers.

Players subscribe to participate in tournament rounds or single games of games such as blackjack. Subscribing is effected with the game administrator by providing user identification information and paying a subscription fee to access the game site maintained by the game server. The system can function in a peer to peer mode that relies on the computing power of the participants computers rather than an administrative server. This enables players to participate in both regular tournaments that occur during their subscription period as well as in regular “ring” games that may be held throughout the period. Tournament winners can be determined through an elimination process based on their play. Tournament winners and runner-ups receive rewards, such as cash prizes based on their performance. Non-subscribing members have the ability to participate in tournaments or ring games by utilizing an alternative method of entry. This alternative method of entry may require the submission of identifying information, but does not require consideration, such as the payment of a subscription fee or game entry fee.

A new player client computer accesses the subscription and game server computers over the Internet through a web-based interface. The player accesses the website hosted by the game server. It is determined whether the player is a subscriber for the game. Should the player not be a subscriber, a subscription process is executed on the subscription server at step 406. The subscription process generally includes obtaining all relevant personal information from the user (name, address, etc.) as well as credit card information, age verification, postal address verification, e-mail address verification, and screen name information (for further use of the site). This subscription also generally requires the payment of a subscription fee.

A player who has paid the subscription or subscription fee is a “subscription player”. A player who has registered with the game site without paying is a “non-subscription player”. Both subscription and non-subscription players are required to provide personal or identifying information with the game server and can then be considered “member” players.

After a user registers by subscribing with the game server, the new user downloads the game client portion of the software to play on the game site, step 408. The client side version of the game software can be actual programming code that is designed to work with the server side modules executed on the game server, or it can be a validation or access modules that allow the client computer to access the game server. The client side software is made available for download to each client computer from the game server. The download page served by the game server includes instructions on how to download and install the software on the client computer.

When a player has registered or subscribed with the game server, the player is eligible to participate in any of the ring games or tournaments that are held during the valid subscription period. Each player must then register for the individual games or tournaments in which they wish to participate. Once a player registers for a game or tournament, the player logs in to the game server to play that game. If it is determined that the player is already a subscribed member, the player skips the game server subscription page and proceeds to the game/tournament subscription and logs in through a login page to gain access to the game server.

The game server determines the games that the user is eligible to play and displays the selection to the user. A wide variety of different online games can be made available. The eligibility of each individual user to play a game can depend on a number of different factors, such as user preferences, game playing history, and so on. The user selects a game from the displayed menu and the game server manages the game and/or tournament play for the user.

After a game or tournament is concluded, the appropriate prizes are distributed to the qualifying winners. The prizes are distributed in the form of a qualification to participate in a later game and/or a game which is to be filmed for television. In this sense the prize is a participation in a television show.

Subscribers pay a fee per defined period which provides unlimited ability to play in daily, weekly, and monthly online game tournaments (as well as ongoing “ring” play) that are hosted by the system. Subscription terms can be flexible, and different pricing packages can be offered. Payment can be by credit cards, checks, electronic funds transfer or debit cards, or other valid methods of payment. Subscribers provide information for age verification (only players who are 18 years and over will be permitted to play), a valid e-mail address, a valid mailing address, and an agreement to abide by the stated terms and conditions of the game administrator and/or website administrator.

In a subscription process each player establishes an account and typically pays a subscription fee to maintain this account. The system also allows non-registered users to participate in a game or tournament through an alternative method of entry. Non-registered players enter the system as a non-registered player by providing suitable identifying information and complying with certain restrictions regarding their participation, and then logs in and downloads the game software in the same manner as a registered player. The system initially checks to see whether the non-registered player is already a member, and then the process proceeds through the game subscription and game hosting.

Non-registered players are required to download a non-registered form from the game administrator website, which they fill in and mail to the company in an appropriate envelope. The non-registered form requires the customer to provide their name, a valid mailing address, a valid e-mail address, a valid credit card (for age verification) and a listing of the games or tournament they wish to participate in, as well as any other required information. Each tournament or individual ring game entry can require a separate entry form for each non-registered customer to be submitted, and only one non-registered entry is allowed per person per game or tournament. There can be restrictions, such as that forms be received a certain number of business days prior to the start of a tournament to be valid, and that non-registered customers register (without payment) to confirm their attendance at a tournament within a set number of hours before the start of the tournament. During the game or tournament, non-registered customers are treated with equal dignity in that they are given an equal chance to win a particular game or tournament and are treated the same as registered players during each game.

The game server 327 hosts a number of different on-line games during the subscription periods for subscribing and non-registered players. In general, the games hosted by the server are games that require active player participation and decision making processes during the course of game play. This excludes games or betting systems in which play and game outcome are automatically determined through the computer software, or through predetermined playing commands or rules.

As illustrated in FIG. 3, the interface between the game server computer and the user client computers is implemented through web-based Internet connections. The game server 327 hosts a game site through one or more web pages accessible through a web server 325. Client side portions of the game software are downloaded and executed on the client computers 302 and 304, and the users access the game site web pages through local web browser programs 312 and 314.

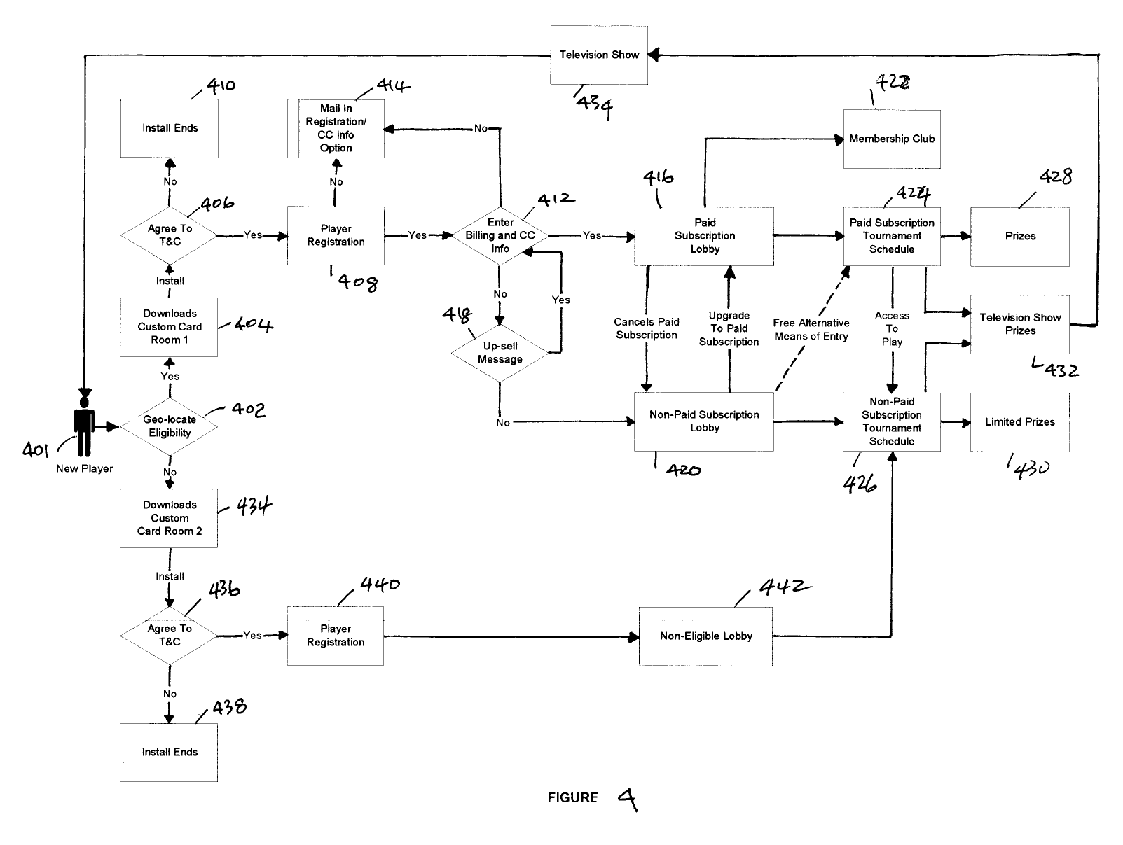

As shown in FIG. 4 new player 401 accesses the system through the internet. The first determination is the eligibility geographically as indicated in step 402. If the player is eligible the next step is to download the custom card room 1 404 and after installation, if there is an agreement to the terms and conditions, as is indicated in Step 406 the player is registered as indicated in step 408.

If there is no agreement, the install ends as indicated in 410. After player registration in step 408, there are two options if the registered players enters the billing and credit card information as indicated in step 412, the subscription process continues. If this is not entered or the player registration at 408 chooses to mail in the registration credit card information, this is an option as indicated in block 414.

After all the successful registration is effective, the player would enter the paid subscription lobby as indicated in block 416. If this is unsuccessful as indicated in block 412, there is a cell message at block 418 which in turn can revert to the block 412. If the end of the process is a non-subscription participant, the player is directed to step 420, the non-paid subscription lobby. There can be interaction between the subscription lobby 416 and the non-paid subscription lobby 420 as indicated by the lines between those two bocks.

From the paid subscription lobby 416, the system provides a membership club 422 and a paid subscription tournament schedule 424. From the non-paid subscription lobby 420 that player has a free alternative means of entry to the paid subscription tournament schedule 424 and additionally access to a non-paid subscription tournament schedule 426.

The paid subscription tournament schedule has designated prizes 428. The non-paid subscription has limited prizes 430. Both the schedules 424 and 426 provide access to the television show prizes 432. This show prize is an option and possibility to participate as a participant in a television show 432 as indicated.

At the beginning of the process, if the player 401 does not meet the geographic location eligibility 402 requirements, the player is directed to download custom card room 2 as indicated by block 434. This is installed and the player needs to agree to the terms and conditions as indicated by block 436. If there is no agreement, the install ends as indicated by block 438. If there is an agreement, the player registration is indicated by block 440 and return of the player is recorded in the non-eligible lobby 442. From there the player is directed to the non-paid subscription tournament schedule 426.

As indicated in FIG. 5, the flow of the participation is indicated for a registered player who is eligible 502 and also a registered player who is non-eligible 503. The registered player 502 would log in at 504. The subscription status is checked at 506. If the subscription status is in good order the player is directed to the paid subscription lobby 416 and the process continues as described with regard to FIG. 4. If this subscription status is not in good order the player is directed to the non-paid subscription lobby 420 and the process continues as described with reference to FIG. 4. A registered player non-eligible as indicated by 503 will go into the login 505 and then in turn into the non-eligible lobby 442.

Users who have subscribed or entered a valid non-registered entry form can also access the website of the game server. For games or tournaments in which players are given a number of chips or tokens to bet, the non-paying non-registered members are given at least the same number of chips as registered paying members. In general, the non-registered members can be given the same number of starting chips or tokens as registered players.

Many other forms of the disclosure exist. For instance, instead of applying the television broadcast of winners of qualifying blackjack games, the broadcast could be applied to other tournament games, such as poker. There could also be several television broadcasts, for instance one or more broadcasts of qualifiers, and wherein winners of these broadcast tournaments qualify for yet a further level of television broadcast. This could be a broadcast of several winners thereby to be a broadcast of an ultimate winner tournament to determine an ultimate final winner.

In different forms of broadcast there can be television broadcasting over the public media at an appropriate broadcast frequency, satellite or cable broadcasting or streaming through the internet. The receiver of the broadcast can be a fixed or mobile screen or receiver device.

Different games of skill such as different forms of blackjack or poker are covered by the disclosure. Also included are games of chance are included such as lottery games, craps, roulette, keno, bingo, slot machines, or horse races.

The disclosure has related to a television prize where there has been no limit to the number of entries a member or a non-member could make in a tournament. There could be variations where either the member or non-member can have a limited number of entries in the tournament. This limit could be for instance one or a different number. Each tournament can have several games as part of that tournament.

Although the disclosure has been described in language specific to structural features and/or methodological acts, it is to be understood that the disclosure defined in the appended claims is not necessarily limited to the specific features or acts described. Rather, the specific features and acts are disclosed as exemplary forms of implementing the claimed disclosure.

What is claimed is:

1. A computer-implemented method of allowing a plurality of players to play a game over a computer network, comprising:
establishing memberships for each of the plurality of players by charging each of the players a fee;
hosting several game tournaments for players for a game that has elements of chance during the membership period, the tournaments including at least one game round, each game round potentially eliminating one or more participant players until a winning player is determined, wherein each of the participant players is required to make playing choices throughout the game;
allowing a non-member player to participate in at least one of the tournaments without payment of the fee by submitting information relating to the non-subscription player prior to the hosting of the tournament;
establishing a prize for the tournaments, the prize being participation in a game tournament for broadcast as a television program, the game tournament on a television including as a player at least one other winner from another game tournament; and
disbursing a further prize to the winning player of the tournament broadcast on television.

2. The method of claim 1 wherein the game tournament is managed by a game administrator operating a game server computer coupled to one or more client computers operated by the participating players.

3. The method of claim 1 wherein the computer network comprises the Internet.

4. The method of claim 1 wherein the game comprises a card game.

5. The method of claim 1 wherein the card game comprises blackjack.

6. The method of claim 1 further comprising the step of establishing a peer to peer network for the plurality of players without a host server computer.

7. The method of claim 1 including players playing a game on a non-networked tour comprising different games in different tournaments.

8. A computer-implemented method of allowing a plurality of players to play a game over a computer network, comprising:
establishing memberships for each of the plurality of players by charging each of the players a fee;
hosting several game tournaments for players for a game that has elements of chance during the membership period, the tournaments including at least one game round, each game round potentially eliminating one or more participant players until a winning player is determined, wherein each of the participant players is required to make playing choices throughout the game;
allowing a non-member player to participate in at least one of the tournaments without payment of the fee by submitting information relating to the non-subscription player prior to the hosting of the tournament;
establishing a prize for the tournaments, the prize being participation in a game tournament for broadcast as a television program, the game tournament on a television including as a player at least one other winner from another game tournament;
disbursing a further prize to the winning player of the tournament broadcast on television; and
the tournament is a card game tournament played in accordance with predetermined game rules by a plurality of players playing a predetermined number of hands in a predetermined number of rounds of the card game tournament comprising:
designating at least one said hand in each said round as an elimination hand in which:
for each said player, a chip total is derived from:
each said player's cards; and
each said player's chip wagers; and
eliminating from the card game tournament the player having the lowest said derived chip total.

9. The method as defined in claim 8, wherein said predetermined number of rounds is one round.

10. The method as defined in claim 8, further comprising establishing an initial chip total for each said player.

11. The method as defined in claim 8, further comprising:
(a) determining a player wager and play order;
(b) placing bets by the plurality of players in order of said wager and play order;
(c) dealing a plurality of cards to the one or more players in order of said wager and play order;
(d) making play decisions, by the players;
(e) resolving, according to the predetermined game rules, whether said play decisions result in said players forfeiting their bets or receiving payouts; and
(f) accumulating new player chip totals as a result of step (e).

12. The method as defined in claim 11, wherein step (d) further comprises a time limit for making play decisions, and if a player fails to make one of said play decisions within said time limit, said player being compelled to stand with dealt cards.

13. The method as defined in claim 12, wherein said time limit is established at one value for a non-elimination hand, and a second value for an elimination hand.

14. The method as defined in claim 13, wherein the predetermined game rules comprise the rules of a blackjack game.

15. The method as defined in claim 12, wherein step (b) further comprises eliminating players who are unable to place at least a mandatory minimum bet.

16. The method as defined in claim 12, wherein step (b) further comprises eliminating players who have a chip total less than said mandatory minimum bet.

17. The method as defined in claim 12, wherein at least one of said bets in step (b) is a secret bet.

18. The method as defined in claim 8, wherein the designating one or more hands as elimination hands step further comprises designating hand numbers 8, 16, and 25 as elimination hands.

19. The method as defined in claim 8, further comprising, when two or more players are tied for said lowest derived chip total, holding a playoff between the tied players.

20. The method as defined in claim 19, wherein the playoff further comprises:
setting a number of playoff hands equal to the number of tied players in the playoff;
establishing a number of playoff chips for each tied player equal to the number of chips belonging to each of said tied players at the beginning of the playoff;
playing, by the tied players, the number of playoff hands;
ranking the tied players based on the number of playoff chips remaining for each of said tied players; and
designating the tied player with the lowest rank as a player to be eliminated.

21. A computer-implemented method of allowing a plurality of players to play a game over a computer network, comprising:
establishing memberships for each of the plurality of players by charging each of the players a fee;
hosting several game tournaments for players for a game that has elements of chance during the membership period, the tournaments including at least one game round, each game round potentially eliminating one or more participant players until a winning player is determined, wherein each of the participant players is required to make playing choices throughout the game;
allowing a non-member player to participate in at least one of the tournaments without payment of the fee by submitting information relating to the non-subscription player prior to the hosting of the tournament;
establishing a prize for the tournaments, the prize being participation in a game tournament for broadcast as a television program, the game tournament on a television including as a player at least one other winner from another game tournament;
disbursing a further prize to the winning player of the tournament broadcast on television; and
the tournament is a card game tournament played in accordance with predetermined game rules by a plurality of players wherein there is a wagering in a hand of cards, the method comprising:
before cards are dealt, a player rendering an indicia of a bidden bet, the indicia indicating a first monetary value of the hidden bet; and
after cards are dealt, said player modifying the indicia to a second monetary value of the hidden bet.

22. The method as defined in claim 21, further comprising establishing a predetermined time limit for rendering said hidden bet.

23. The method as defined in claim 21, further comprising eliminating said player from a tournament if said player possesses a chip total representing an amount less than the sum of said first monetary value and second monetary value.

24. The method as defined in claim 21, further comprising:
revealing said hidden bet; and
reconciling said first amount of monetary value and said second amount of monetary value as if said first amount and second amount had been placed as non-confidential wagers.

25. A computer-implemented method of allowing a plurality of players to play a game over a computer network, comprising:
establishing memberships for each of the plurality of players by charging each of the players a fee;
hosting several game tournaments for players for a game that has elements of chance during the membership period, the tournaments including at least one game round, each game round potentially eliminating one or more participant players until a winning player is determined, wherein each of the participant players is required to make playing choices throughout the game;
allowing a non-member player to participate in at least one of the tournaments without payment of the fee by submitting information relating to the non-subscription player prior to the hosting of the tournament;
establishing a prize for the tournaments, the prize being participation in a game tournament for broadcast as a television program, the game tournament on a television including as a player at least one other winner from another game tournament;
disbursing a further prize to the winning player of the tournament broadcast on television; and
the tournament is a card game tournament played in accordance with predetermined game rules by a plurality of players wherein there is a card game tournament played in accordance with predetermined game rules by a plurality of players, the card game tournament having a predetermined number of rounds and a predetermined number of hands to be played in each of the predetermined number of rounds, the method comprising:
designating one or more of said hands to be played as an elimination hand;
before cards are dealt, one or more said players rendering an indicia of a hidden bet, the indicia indicating a first monetary value of the hidden bet;
dealing cards to said plurality of players;
after cards are dealt:
said one or more said players modifying the indicia to a second monetary value of the hidden bet;
adjusting an individual chip total for each of said players;
ranking the players in order of their individual chip totals; and
when said hand being played is an elimination hand, removing from the tournament the player that was ranked lowest in said ranking step.

26. The method as defined in claim 25, further comprising removing from the tournament any of said players that have a chip total below a mandatory minimum bet amount.

27. The method as defined in claim 25, wherein said adjusting an individual chip total for each of said players further comprises:
revealing the hidden bet;
reconciling the player's card play according to said predetermined game rules;
grading the first monetary value and second monetary value as if said first monetary value and second monetary values had been placed as bets with chips;
awarding to said player an amount of chips, if required by said predetermined game rules; and
decrementing said player's chip total if required by said predetermined game rules.

28. A computer-implemented method of allowing a plurality of players to play a game over a computer network, comprising:
establishing memberships for each of the plurality of players by charging each of the players a fee;
hosting several game tournaments for players for a game that has elements of chance during the membership period, the tournaments including at least one game round, each game round potentially eliminating one or more participant players until a winning player is determined, wherein each of the participant players is required to make playing choices throughout the game;
allowing a non-member player to participate in at least one of the tournaments without payment of the fee by submitting information relating to the non-subscription player prior to the hosting of the tournament;
establishing a prize for the tournaments, the prize being participation in a game tournament for broadcast as a television program, the game tournament on a television including as a player at least one other winner from another game tournament;
disbursing a further prize to the winning player of the tournament broadcast on television; and
the tournament is a card game tournament played in accordance with predetermined game rules by a plurality of players wherein there is a wagering in a hand of cards, the method comprising:
before cards are dealt, rendering an indicia of a hidden bet of a player;
indicating a monetary value of the hidden bet of the player before a camera; and
revealing said monetary value of the hidden bet to at least one person not participating in said hand of cards.

29. The method as defined in claim 28, wherein said camera is situated at a location not visible to a second player participating in said hand of cards, and said one person not participating in said hand of cards views an image produced by said camera.

30. The method as defined in claim 28, wherein said camera produces a video feed.

31. The method as defined in claim 30, wherein said video feed is recorded for broadcast.

32. The method as defined in claim 30, wherein said video feed is transmitted by radio frequency broadcast.

33. The method as defined in claim 30, wherein said video feed is provided to a cable television network.

34. The method as defined in claim 30, wherein said video feed is distributed to subscribers of a cable television service.

35. The method as defined in claim 30, wherein said video feed from said camera is displayed to an audience.

36. The method as defined in claim 30, further comprising:
delaying said video feed from said camera by a predetermined period of time; and
broadcasting the delayed video feed.

37. The method as defined in claim 30, wherein said video feed is simultaneously displayed to an audience in attendance at said hand of cards and recorded for broadcast.

38. The method as defined in claim 30, wherein said video feed is simultaneously displayed to an audience in attendance at said hand of cards and broadcast live.

39. A computer-implemented method of allowing a plurality of players to play a game over a computer network, comprising:
establishing memberships for each of the plurality of players by charging each of the players a fee;
hosting several game tournaments for players for a game that has elements of chance during the membership period, the tournaments including at least one game round, each game round potentially eliminating one or more participant players until a winning player is determined, wherein each of the participant players is required to make playing choices throughout the game;
allowing a non-member player to participate in at least one of the tournaments without payment of the fee by submitting information relating to the non-subscription player prior to the hosting of the tournament;
establishing a prize for the tournaments, the prize being participation in a game tournament for broadcast as a television program, the game tournament on a television including as a player at least one other winner from another game tournament;
disbursing a further prize to the winning player of the tournament broadcast on television; and
the tournament is a card game tournament played in accordance with predetermined game rules by a plurality of players wherein there is a method of playing a hand of blackjack comprising:
before each player is dealt at least two cards, each said player optionally placing:
a secret bet token on the blackjack table; and
a secret bet card indicating a secret wager under the secret bet token;
after each player is dealt at least two cards, each said player optionally placing an additional wager; and
after a result is determined for each player's hand:
revealing each secret wager; and
summing, for each said player, the secret and additional wagers.

40. The method as defined in claim 39, where said additional wager comprises a secret bet.

41. The method as defined in claim 40, further comprising eliminating a secret betting player having game chips less than sum of said secret betting player's secret and additional wagers.

42. The method of claim 8 wherein the game tournament is managed by a game administrator operating a game server computer coupled to one or more client computers operated by the participating players.

43. The method of claim 8 wherein the computer network comprises the Internet.

44. The method of claim 8 including players playing a game on a non-networked tour comprising different games in different tournaments.

45. The method of claim 21 wherein the game tournament is managed by a game administrator operating a game server computer coupled to one or more client computers operated by the participating players.

46. The method of claim 21 wherein the computer network comprises the Internet.

47. The method of claim 21 including players playing a game on a non-networked tour comprising different games in different tournaments.

48. The method of claim 1 wherein a player is limited to a defined number of entries in a tournament.

49. The method of claim 8 wherein a player is limited to a defined number of entries in a tournament.
